(19) United States
(12) Patent Application Publication
(10) Pub. No.: US 2006/0198656 A1
(43) Pub. Date: Sep. 7, 2006

(54) Toner cartridge seal assembly

(75) Inventors: Lawrence Dale Lewis, Sanford, NC (US); Charles Stanley Rice JR., Mauldin, SC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/073,388

(22) Filed: Mar. 4, 2005

(51) Int. Cl. G03G 15/08

(52) U.S. Cl. 399/106

(57) ABSTRACT

A seal assembly for use in an imaging cartridge includes a gasket having an elongate gasket opening and a seal having first and second sides. The first side of the seal is at least partially affixed to a first side of the gasket and covers the gasket opening. The seal includes a seal tail extending over at least a portion of the second side of the seal such that an underside of the seal tail is adjacent to the second side of the seal. A tying element affixes the underside of the seal tail to the seal assembly.

### BACKGROUND

The present invention generally relates to seals, gaskets and the like, and more particularly to a seal or gasket to retain or seal toner in a printer toner cartridge or the like.

In the imaging industry, there is a growing market for the remanufacture and refurbishing of various types of replaceable imaging cartridges such as toner cartridges, drum cartridges, inkjet cartridges, and the like. These imaging cartridges are used in imaging devices such as laser printers, xerographic copiers, inkjet printers, facsimile machines and the like, for example. Imaging cartridges, once spent, are unusable for their originally intended purpose. Without a refurbishing process these cartridges would simply be discarded, even though the cartridge itself may still have potential life. As a result, techniques have been developed specifically to address this issue. These processes may entail, for example, the disassembly of the various structures of the cartridge, replacing toner or ink, cleaning, adjusting or replacing any worn components and reassembling the imaging cartridge.

Imaging cartridges include one or more compartments holding the marking material which is deposited on a surface, such as paper. For a laser toner cartridge, this compartment is referred to as the toner hopper. During the remanufacture of a laser toner cartridge, any remaining residual toner should be removed from the toner hopper and the toner hopper should be cleaned. New toner is then placed in the toner hopper and the hopper opening is then sealed with a toner hopper seal. The purpose of the toner hopper seal is to ensure that toner does not migrate from the toner hopper during shipping of the toner cartridge package. Being a fine, dry powder, toner will migrate throughout the package and may damage other components of the toner cartridge. Such toner migration will also create an esthetically unpleasing mess for the end user. If the toner is not confined to the toner hopper, the end users may have toner on their hands and clothes.

A variety of seals have been used to seal or reseal toner hoppers. One seal assembly includes a gasket having a removable seal covering the opening in the gasket.

The removable seal includes a tail. During the installation of the seal assembly, this tail is laid back over the removable seal and an end portion of the tail is placed through an opening between the toner hopper and the developer roller housing. The end user pulls the tail to remove at least a portion of the seal, allowing toner to migrate through the gasket opening from the toner hopper to the developer roller. However, during the installation of the seal assembly, the tail must be properly aligned with the rest of the seal assembly. This alignment requires extra time and labor, and if not performed correctly, may result in an inoperable installation. Therefore, it would be advantageous to provide a seal assembly which includes a seal tail which attached to the seal assembly in the aligned position.

### SUMMARY

In one aspect of the present invention, a seal assembly for use in an imaging cartridge includes a gasket having an elongate gasket opening and a seal having first and second sides. The first side of the seal is at least partially affixed to a first side of the gasket and covers the gasket opening. The seal includes a seal tail extending over at least a portion of the second side of the seal such that an underside of the seal tail is adjacent to the second side of the seal. A tying element affixes the underside of the seal tail to the seal assembly.

A more complete understanding of the present invention, as well as further features and advantages of the invention, will be apparent from the following detailed description and the accompanying drawings.

### BRIEF DESCRIPTION OF THE DRAWINGS

FIG. 1 shows a side view of a seal assembly in accordance with the present invention;

FIG. 2 shows a top view of a seal assembly in accordance with the present invention;

FIG. 3 shows a partially exploded view of a seal assembly in accordance with the present invention;

FIGS. 4-6 show respectively a side view, top view and bottom view of a seal assembly in accordance with another aspect of the present invention;

FIG. 7 shows a perspective view of a toner hopper of a toner cartridge including a seal assembly in accordance with the present invention.

### DETAILED DESCRIPTION

The following detailed description of preferred embodiments refers to the accompanying drawings which illustrate specific embodiments of the invention. In the discussion that follows, specific systems and techniques for manufacturing or forming a seal assembly having an aligned seal tail are disclosed. Other embodiments having different structures and operations for the manufacture of other types of seals or seal assemblies including an aligned seal tail do not depart from the scope of the present invention.

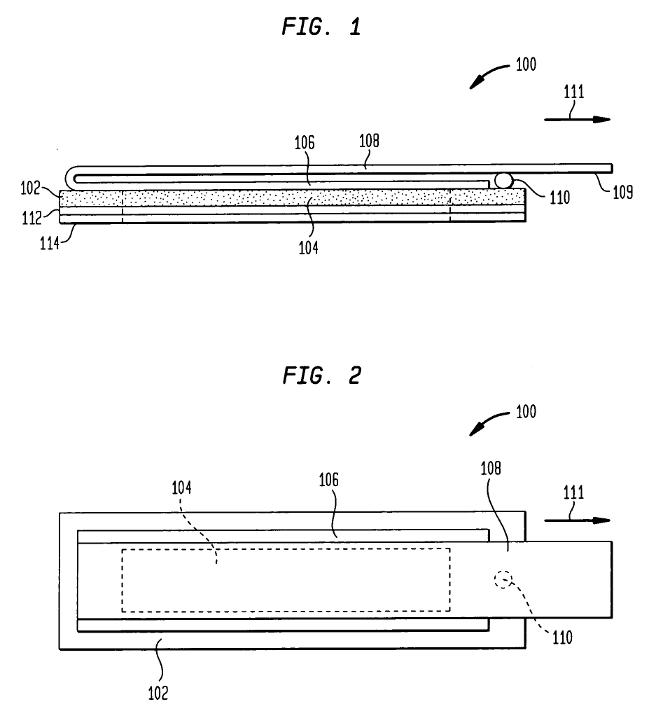

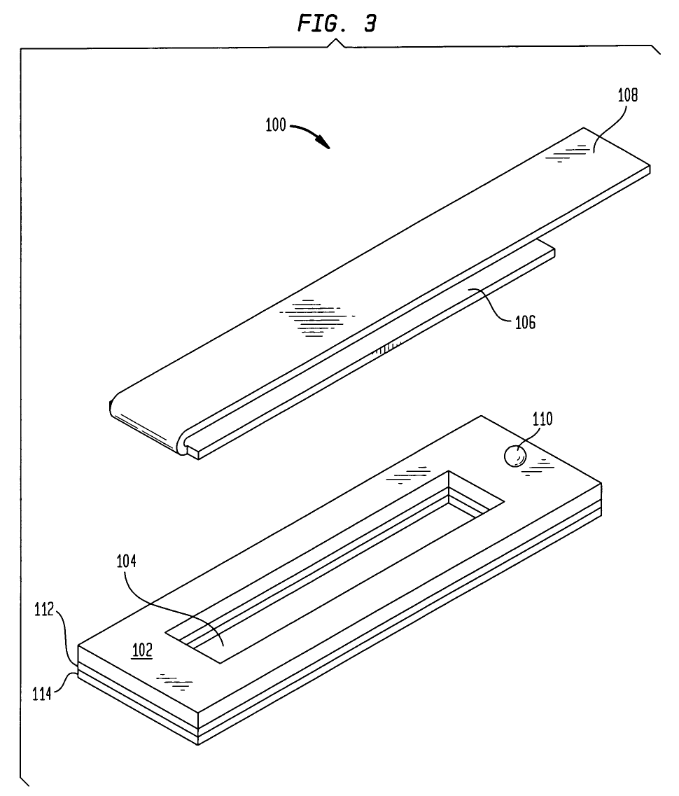

FIGS. 1 and 2 show respectively a side view and a top view of a seal assembly 100 in accordance with the present invention. FIG. 3 shows a partially exploded perspective view of the seal assembly 100 in accordance with the present invention. The seal assembly 100 is intended to be placed over the opening of a toner hopper of an imaging cartridge after the toner has been placed into the toner hopper. The seal assembly 100 comprises a gasket 102 having a gasket opening 104 running down the length of the gasket 102. The size of the gasket opening 104 may conform generally to the size of the opening of the toner hopper. The gasket 102 may suitably comprise a foam (such as a semi-rigid foam, an open cell foam, or a closed cell foam, for example), plastic (such as polystyrene), a rigid material, or other suitable materials.

The seal assembly 100 further comprises a removable seal 106 having a seal tail 108. As shown in FIGS. 1-3, the removable seal 106 may be integral with the seal tail 108. Alternately, the seal tail 108 may be a separate material permanently attached to the removable seal 106. The removable seal 106 and the seal tail may suitably comprise a synthetic material, such as polyester or polypropylene, for example.

The removable seal 106 covers the gasket opening 104 and is adhered by heat sealing or adhesive, for example, to one side of the gasket 102. The seal tail 108 is folded back over the removable seal 106 and is held longitudinally in an aligned position by a tying element 110 that adheres the underside 109 of the seal tail 108 to another portion of the seal assembly 100. Preferably, the tying element 110 provides a sufficiently strong securing force to hold the seal tail 108 place during the handling and installation of the seal assembly 100, but is weak enough such that the bond can be readily broken when an end user pulls on an end of the seal tail 108 in the direction indicated by arrow 111. The adhesive binding strength of the tying element may be less than 0.70 pounds, per ASTM D3330 peel test.

As seen more clearly in FIG. 2, the tying element 110 secures the seal tail 108 in an aligned position with respect to the rest of the seal assembly 100, facilitating the ease of installation of the seal assembly 100 on a toner hopper. In a preferred embodiment, the tying element 110 comprises a small glue dot, such as a hot melt styrene-isoprene-styrene (SIS) rubber glue, for example, which adheres the underside 109 of the seal tail 108 to the top surface of the gasket 102. In another aspect, the tying element 110 may comprise an adhesive layer, such as double sided tape, or other suitable materials. In another aspect, the tying element may adhere the underside 109 of the seal tail 108 to another portion of the seal assembly, such as a top side of the removable seal 106, for example.

As seen in FIGS. 2 and 3, the removable seal 106 may have a greater width than the seal tail 108. In such a case, a center portion of the removable seal 106 will be tom out of the seal assembly 100 when an end user pulls the seal tail 108. Alternately, the removable seal 106 and the seal tail 108 may share a common width. In such a case, the entire removable seal 106 will be separated from the seal assembly 100 when an end user pulls the seal tail 108.

To allow for the attachment of the seal assembly 100 to the toner hopper opening, an adhesive layer 112 preferably covers the bottom side of the gasket 102. The adhesive layer 112 may suitably comprise rubber, acrylic, a structural carrier, or a combination of such materials, for example. The adhesive layer 112 may be covered by a release liner 114 to protect the adhesive layer 112 until the release liner is removed prior to attachment of the seal assembly 100 to the toner hopper. Both the adhesive layer 112 and the release liner may include an opening corresponding the gasket opening 104. In an alternate embodiment, the gasket 102 may be affixed to the toner hopper by other suitable techniques, such as gluing, for example.

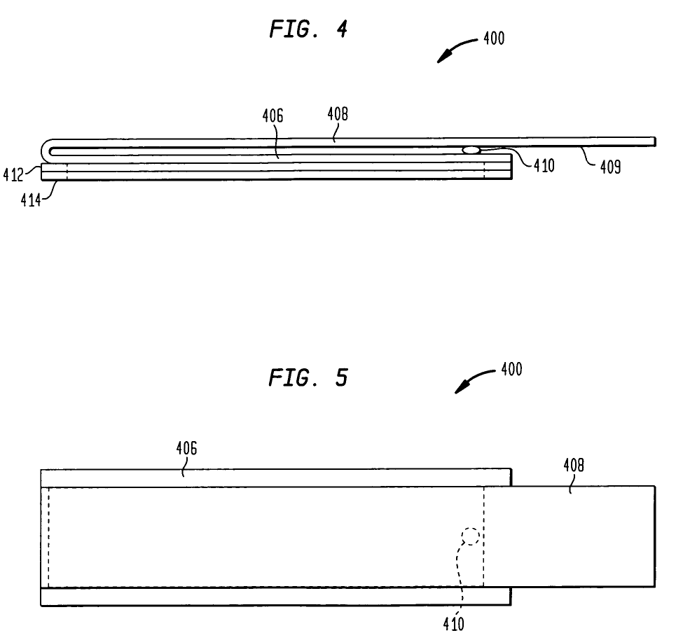

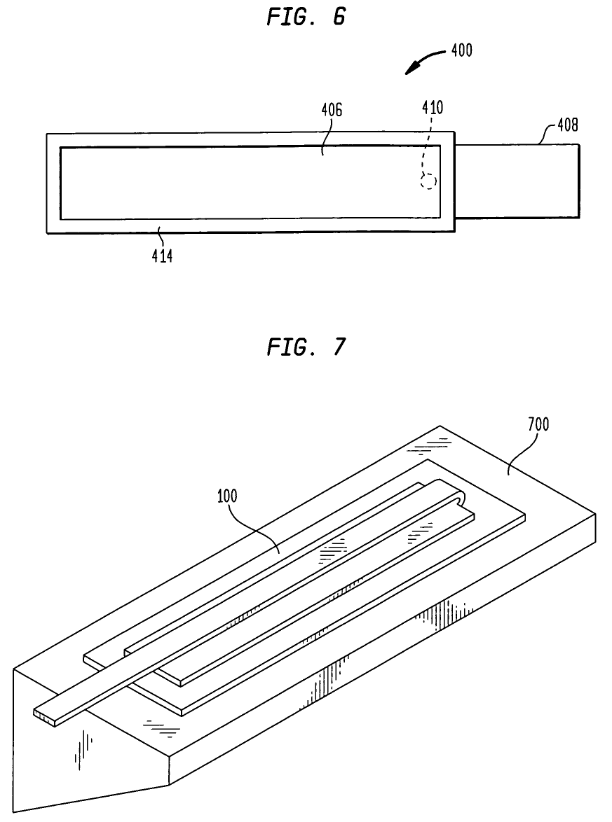

FIGS. 4-6 show a seal assembly 400 in accordance with another aspect of the present invention. The seal assembly 400 is substantially similar to the seal assembly 100 and may comprise the same type materials of the seal assembly 100, but does not include a gasket. The seal assembly 400 comprises a removable seal 406 having a seal tail 408. The seal tail 408 is folded back over the removable seal 406 and is held longitudinally in an aligned position by a tying element 410 which adheres the underside 409 of the seal tail 408 to a top side of the removable seal 406. To allow for attachment of the seal assembly 400 to the toner hopper opening, an adhesive layer 412 preferably covers the outer perimeter of the bottom side of the removable seal 406. The adhesive layer 412 may be covered by a release liner 414. When the end user pulls the seal tail 408 of an installed seal assembly 400, a center portion of the removable seal 406 will be torn away, allowing toner to migrate from the toner hopper.

FIG. 7 shows the seal assembly 100 affixed to a toner hopper 700 in accordance with the present invention.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A seal assembly for use in an imaging cartridge comprising:
a gasket having an elongate gasket opening;
a removable seal having first and second sides, said first side of the removable seal at least partially affixed to a first side of the gasket and covering the gasket opening, said removable seal including a seal tail extending over at least a portion of the second side of the removable seal such that an underside of the seal tail is adjacent to the second side of the removable seal; and
a tying element affixing the underside of the seal tail to the seal assembly.

2. The seal assembly of claim 1 wherein the tying element affixes the underside of the seal tail to the first side of the gasket.

3. The seal assembly of claim 1 wherein the tying element affixes the underside of the seal tail to the second side of the removable seal.

4. The seal assembly of claim 1 further comprising an adhesive affixed to a second side of the gasket adapted for attaching the seal assembly over a toner hopper opening of an imaging cartridge.

5. A seal assembly for use in an imaging cartridge comprising:
a removable seal having first and second sides, said first side of the removable seal at least partially affixed to an adhesive layer, said removable seal including a seal tail extending over at least a portion of the second side of the removable seal such that an underside of the seal tail is adjacent to the second side of the removable seal; and
a tying element affixing the underside of the seal tail to the seal assembly.

6. The seal assembly of claim 5 wherein the tying element affixes the underside of the seal tail to the second side of the removable seal.

7. The seal assembly of claim 5 wherein the adhesive layer is adapted for attaching the seal assembly over a toner hopper opening of an imaging cartridge.

8. An imaging cartridge comprising:
a toner hopper including a toner hopper opening; and
a seal assembly comprising
a gasket having an elongate gasket opening;
a removable seal having first and second sides, said first side of the removable seal at least partially affixed to a first side of the gasket and covering the gasket opening, said removable seal including a seal tail extending over at least a portion of the second side of the removable seal such that an underside of the seal tail is adjacent to the second side of the removable seal;
a tying element affixing the underside of the seal tail to the seal assembly; and
an adhesive affixed to a second side of the gasket attaching the seal assembly over a toner hopper opening of an imaging cartridge.

9. The seal assembly of claim 8 wherein the tying element affixes the underside of the seal tail to the first side of the gasket.

10. The seal assembly of claim 8 wherein the tying element affixes the underside of the seal tail to the second side of the removable seal.
